(19) United States
(12) Patent Application Publication
(10) Pub. No.: US 2026/0117877 A1
(43) Pub. Date: Apr. 30, 2026

(54) THERMAL INSULATING VALVE HANDLE WITH MEMORY STOP AND LOCKING MECHANISM

(71) Applicant: MILWAUKEE VALVE COMPANY, LLC, New Berlin, WI (US)

(72) Inventors: David Byrd, Poyntette, WI (US); Aaron Trefftzs, Prairie Du Sac, WI (US); Brian Suchla, Lodi, WI (US); Austin Schmidt, Sauk City, WI (US); Ryan Murphy, Mequon, WI (US)

(21) Appl. No.: 18/930,659

(22) Filed: Oct. 29, 2024

(51) Int. Cl. F16K 5/06; F16K 31/60; F16K 35/00; F16K 37/00

(52) U.S. Cl. CPC F16K 5/0647; F16K 31/60; F16K 35/00; F16K 37/0058

(57) ABSTRACT

A handle for a valve assembly having a valve member. The handle includes a body configured to be coupled to the valve member, a body insert including a head that is graspable for opening and closing the valve member, and an adjustable stop assembly. The adjustable stop assembly is positioned on and engaged with the body insert and includes a first plate, a second plate, and a fastener. The first plate is rotatable relative to the body insert between an open state, a closed state, and a memory-stop state, each of which corresponds to a different orientation of the valve member. The fastener couples the first plate and the second plate together. The fastener is engageable by a user to move the first plate to the memory-stop state. The valve member is at least partially open when the first plate is in the memory-stop state.

### FIELD OF THE DISCLOSURE

The present disclosure relates to a valve assembly, and more specifically, a handle for a valve assembly.

### SUMMARY

In one aspect, the disclosure provides a valve assembly including a valve member and a handle. The valve member includes a pipe connector body and a ball. The pipe connector body is configured to be installed in a fluid flow system. The ball is positioned within the pipe connecter body and is rotatable relative to the pipe connector body to selectively permit and inhibit fluid flow from the fluid flow system through the pipe connector body. The handle includes a body, a body insert, and an adjustable stop assembly. The body is configured to be coupled to the valve member at an end of the body and includes a head positioned opposite from the end of the body that is coupled to the valve member. The head is graspable to open and close the valve member. The body insert is received in the body and is configured to rotate relative to the body. The body insert includes a flange and a tab that protrudes from the flange in a direction away from the end of the body that is coupled to the valve member. The adjustable stop assembly is engaged with the body insert. The adjustable stop assembly includes a first plate positioned on the flange of the body insert, a second plate positioned on top of the first plate such that the first plate is positioned between the body insert and the second plate, and a fastener that couples the first plate and the second plate together. The first plate is rotatable relative to the body insert between an open state, a closed state, and a memory-stop state, each of the open state, the closed state, and the memory-stop state corresponding to a different orientation of the valve member. The fastener is engageable by a user to move the first plate to the memory-stop state. Opening the handle while the first plate is in the memory-stop state is configured to at least partially open the valve member.

In some aspects, the open state corresponds to an orientation of the valve member in which the ball permits a maximum amount of fluid flow through the pipe connector body, wherein the closed state corresponds to an orientation of the valve member in which the ball inhibits fluid flow through the pipe connector body, and wherein the memory-stop state corresponds to any orientation of the ball in which the ball permits a non-zero amount of fluid flow through the pipe that is less than the maximum amount permitted in the open state.

In some aspects, the first plate includes a first shoulder, a second shoulder, and a slot defined between the first shoulder and the second shoulder. In the open state, the tab is positioned adjacent to the first shoulder. In the closed state, the tab is positioned adjacent to the second shoulder. In the memory-stop state, the tab is positioned at any location along the slot between the first shoulder and the second shoulder.

In some aspects, the fastener is selectively tightenable without using tools to couple the second plate to the first plate and inhibit movement of the first plate relative to the second plate, and wherein the fastener is selectively loosenable without using tools to permit movement of the first plate relative to the second plate.

In some aspects, the second plate includes an adjustment slot and the fastener is inserted through the adjustment slot to couple the second plate to the first plate, and wherein with the fastener loosened, the fastener is movable along the adjustment slot to move the first plate to the memory-stop state.

In some aspects, the adjustment slot includes a first end and a second end, wherein with the fastener positioned at one of the first end and the second end, the first plate is in the closed state.

In some aspects, the fastener is a first fastener, the adjustment stop assembly further including a second fastener, wherein the adjustment slot is a first adjustment slot, the adjustment stop assembly further including a second adjustment slot and the second fastener is inserted through the second adjustment slot to couple the second plate to the first plate, and wherein with the second fastener loosened, the second fastener is movable along the second adjustment slot to move the first plate to the memory-stop state.

In some aspects, with at least one of the first fastener and the second fastener tightened, the first plate is inhibited from being adjusted to the memory-stop state, and wherein with both of the first fastener and the second fastener loosened, the first plate is permitted to be adjusted to the memory-stop state.

In some aspects, the fastener is a thumb screw.

In some aspects, the handle further includes a removable cover that is selectively coupled to the body to surround the fastener such that the cover inhibits engagement of the fastener while the cover is coupled to the body.

In some aspects, the handle further includes an insulator that inhibits condensation forming on an exterior of the handle due to temperature differentials, and a lock engageable with the adjustable stop assembly to lock the first plate in either the open state or the closed state.

In another aspect, the disclosure provides a valve assembly including a valve member and a handle. The valve member includes a pipe connecter body and a ball. The pipe connector body is configured to be installed in a fluid flow system. The ball is positioned within the pipe connector body and is rotatable relative to the pipe connector body to selectively permit and inhibit fluid flow from the fluid flow system through the pipe connector body. The handle includes a body, a body insert, an adjustable stop assembly, an insulator, and a lock. The body is coupled to the valve member at an end of the body. The body insert is received in the body, the body insert including a flange and a tab that protrudes from the flange in a direction away from the end of the body that is coupled to the valve member. The adjustable stop assembly is engaged with the body insert. The adjustable stop assembly includes a plate positioned on the flange of the body insert and is rotatable relative to the body insert between an open state, a closed state, and a memory-stop state. Each of the open state, the closed state, and the memory-stop state corresponding to a different orientation of the valve member. The insulator is secured to one of the body and the body insert to inhibit condensation forming on an exterior of the handle due to temperature differentials. The lock is engageable with the adjustable stop assembly to lock the first plate in either the open state or the closed state.

In some aspects, the lock is selectively insertable into a lock receptacle to lock the plate in either the open state or the closed state, and wherein each of the body, the body insert, and the plate at least partially defines the lock receptacle.

In some aspects, the plate is a first plate, the adjustable stop assembly further including a second plate on top of the first plate. A body insert recess is formed in the flange of the body insert, wherein a first recess and a second recess are formed in the second plate, wherein with the first plate in the closed state, the first recess is aligned with the body insert such that the body insert recess and the first recess are configured to receive the lock to inhibit the first plate from being adjusted from the closed state, and wherein with the first plate in the open state, the second recess is aligned with the body insert such that the body insert recess and the second recess are configured to receive the lock to inhibit the first plate from being adjusted from the closed state.

In some aspects, the insulator is a plug that is supported within the body insert and creates a thermal barrier between the end of the body that is coupled to the valve member and the adjustable stop assembly.

In some aspects, the insulator is a shield that surrounds the body to inhibit environmental ingress from entering the handle.

In some aspects, the insulator is a first insulator that is positioned within the body insert, the handle further including a second insulator that surrounds the body of the handle.

In another aspect, the disclosure provides a handle for a valve assembly having a valve member. The handle includes a body, a body insert, and an adjustable stop assembly. The body is configured to be coupled to the valve member at an end of the body. The body includes a head positioned opposite from the end of the body that is coupled to the valve member. The head is graspable to open and close the valve member. The body insert is received in the body, the body insert including a flange and a tab that protrudes from the flange in a direction away from the end of the body that is coupled to the valve member. The adjustable stop assembly is engaged with the body insert. The adjustable stop assembly includes a first plate, a second plate, and a fastener. The first plate is positioned on the flange of the body insert and is rotatable relative to the body insert between an open state, a closed state, and a memory-stop state. Each of the open state, the closed state, and the memory-stop state corresponds to a different orientation of the valve member. The second plate positioned on top of the first plate such that the first plate is positioned between the body insert and the second plate. The fastener couples the first plate and the second plate together. The fastener is engageable by a user to move the first plate to the memory-stop state. The valve member is at least partially open when the first plate is in the memory-stop state.

In some aspects, the first plate includes a first shoulder, a second shoulder, and a slot defined between the first shoulder and the second shoulder. In the open state, the tab is positioned adjacent to the first shoulder. In the closed state, the tab is positioned adjacent to the second shoulder. In the memory-stop state, the tab is positioned at any location along the slot between the first shoulder and the second shoulder.

In some aspects, the handle further includes an insulator secured to the body to inhibit condensation forming on an exterior of the handle due to temperature differentials, and a lock engageable with the adjustable stop assembly to lock the first plate in either the open state or the closed state.

Other features and aspects of the present disclosure will become apparent upon consideration of the following description and the accompanying drawings.

### BRIEF DESCRIPTION OF THE DRAWINGS

FIG. 1A is a perspective view of a valve assembly in a closed state and including a valve member and a handle according to one embodiment of the disclosure.

FIG. 1B is a perspective view of the valve assembly of FIG. 1A in an open state.

FIG. 1C is a perspective view of the valve assembly of FIG. 1A in a memory-stop state.

FIG. 2 is an exploded view of the handle of FIG. 1A including a body, a body insert, an adjustment stop assembly, a first end plate, a first insulator, a second insulator, and a cover.

FIG. 3 is a cross-sectional view of the handle of FIG. 1A taken along line 3-3.

FIG. 4A is a first top perspective view of the body and a first end plate of FIG. 2.

FIG. 4B is a bottom perspective view of the body and the first end plate of FIG. 2.

FIG. 4C is a second top perspective view of the body and the first end plate of FIG. 2.

FIG. 5A is a top perspective view of the body insert and the second end plate of FIG. 2.

FIG. 5B is a bottom perspective view of the body insert of FIG. 2.

FIG. 6A is a first exploded view of the adjustment stop assembly of FIG. 2.

FIG. 6B is a second exploded view of the adjustment stop assembly of FIG. 2.

FIG. 7 is a bottom perspective view of the cover of FIG. 2.

FIG. 8A is a top view of the handle in the closed state.

FIG. 8B is a top view of a first portion of the handle in the closed state.

FIG. 8C is a top view of a second portion of the handle in the closed state.

FIG. 8D is a bottom view of the handle in the closed state.

FIG. 9A is a top view of the handle in the open state.

FIG. 9B is a top view of the first portion of the handle in the open state.

FIG. 9C is a top view of the second portion of the handle in the open state.

FIG. 9D is bottom view of the handle in the open state.

FIG. 10 is a top view of the first portion of the handle when the handle is opened in the memory-stop state.

FIG. 11A is a top view of the first portion of the handle in a first exemplary memory-stop state.

FIG. 11B is a top view of the second portion of the handle in the first exemplary memory-stop state.

FIG. 12A is a top view of the first portion of the handle in a second exemplary memory-stop state.

FIG. 12B is a top view of the second portion of the handle in the second exemplary memory-stop state.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

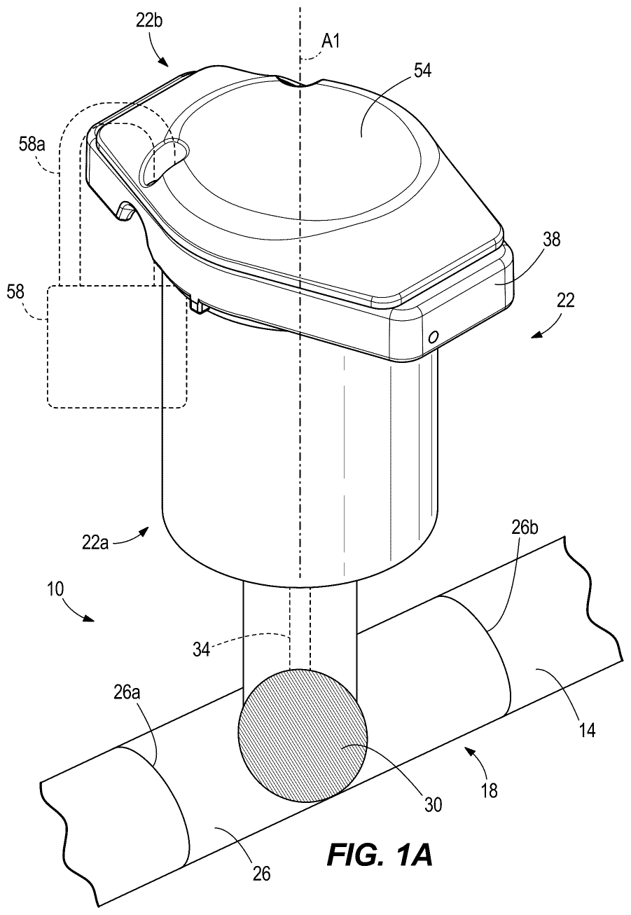

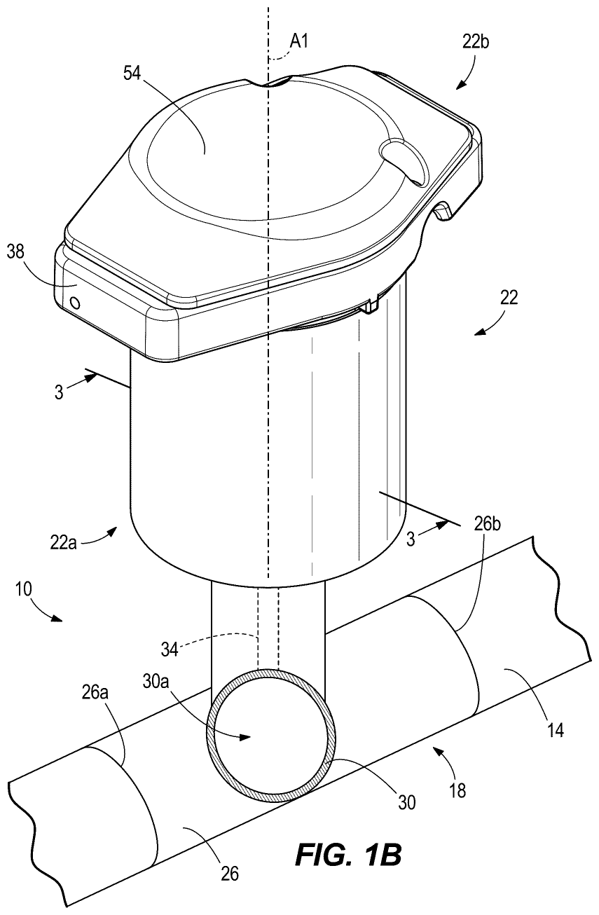

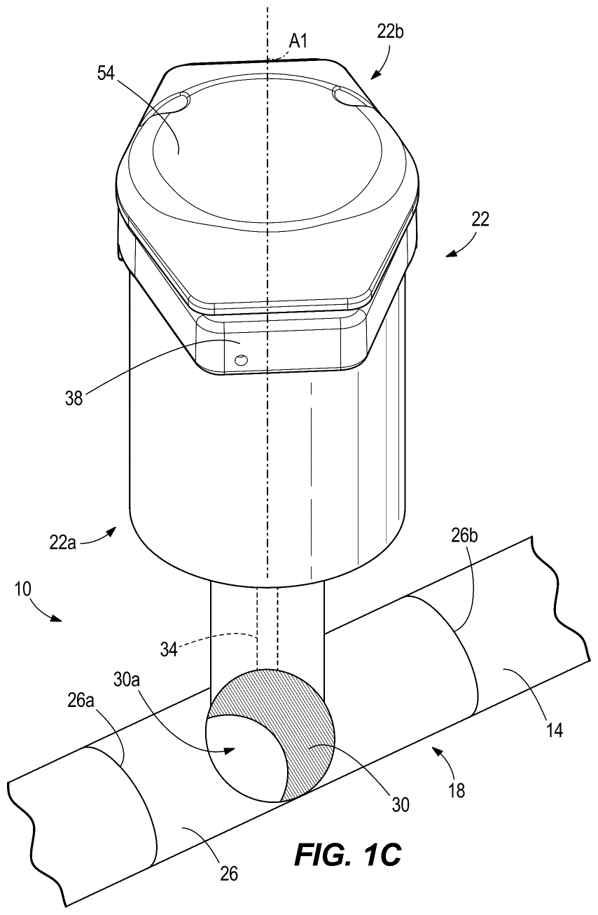

FIGS. 1A-1C illustrate a valve assembly 10 for use with a fluid flow system 14, although only a portion of the fluid flow system 14 is illustrated in FIGS. 1A-1C. The portion of the fluid flow system 14 illustrated in FIGS. 1A-1C is a pipe. The valve assembly 10 is configured to be adjusted between a closed state, as illustrated in FIG. 1A, an open state, as illustrated in FIG. 1B, and a memory-stop state, as illustrated in FIG. 1C to selectively permit and inhibit fluid flow through the fluid flow system 14, as will be described in more detail below. The valve assembly 10 includes a valve member 18 connected to the fluid flow system 14 and a handle 22 connected to the valve member 18. The handle 22 is engageable, or actuatable by a user to adjust the valve assembly 10 between the closed state, the open state, and the memory-stop state.

The illustrated valve member 18 is a ball valve. In other embodiments, the valve member 18 may be another type of valve such as a butterfly valve, a globe valve, a check valve, and the like. The valve member 18 includes a pipe connector body 26, a ball 30, and a stem 34. The pipe connector body 26 includes an inlet end 26a and an outlet end 26b. The pipe connector body 26 is configured to attach, or couple, the valve member 18 to the fluid flow system 14. Specifically, in the illustrated embodiment, each of the inlet end 26a and the outlet end 26b is threaded and forms a threaded attachment between the pipe connector body 26 and the fluid flow system 14. In other embodiments, the inlet end 26a and the outlet end 26b may attach to the fluid flow system 14 through different means. The ball 30 is supported in and is configured to rotate relative to the pipe connector body 26. The ball 30 defines a flow aperture 30a that permits fluid to flow from the inlet end 26a to the outlet end 26b (and vice versa). In some embodiments, fluid flow may be permitted to travel from the inlet end 26a to the outlet end 26b and inhibited from traveling from the outlet end 26b to the inlet end 26a. The stem 34 extends from the ball 30 and may protrude from the pipe connector body 26 to facilitate coupling between the handle 22 and the ball 30 such that rotation of the handle 22 may rotate the ball 30 (e.g., between the closed state, the open state, and the memory-stop state).

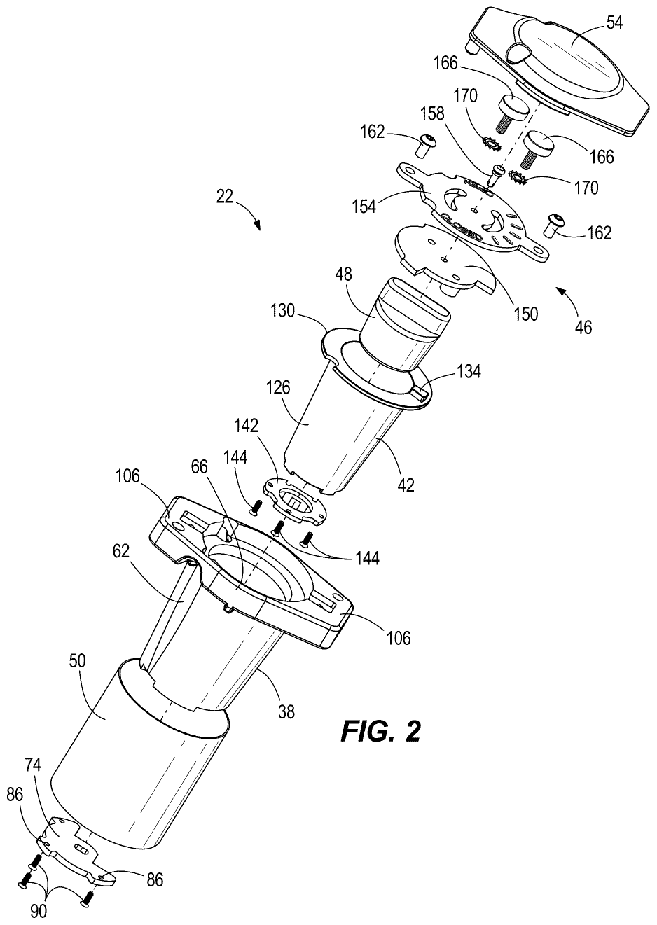

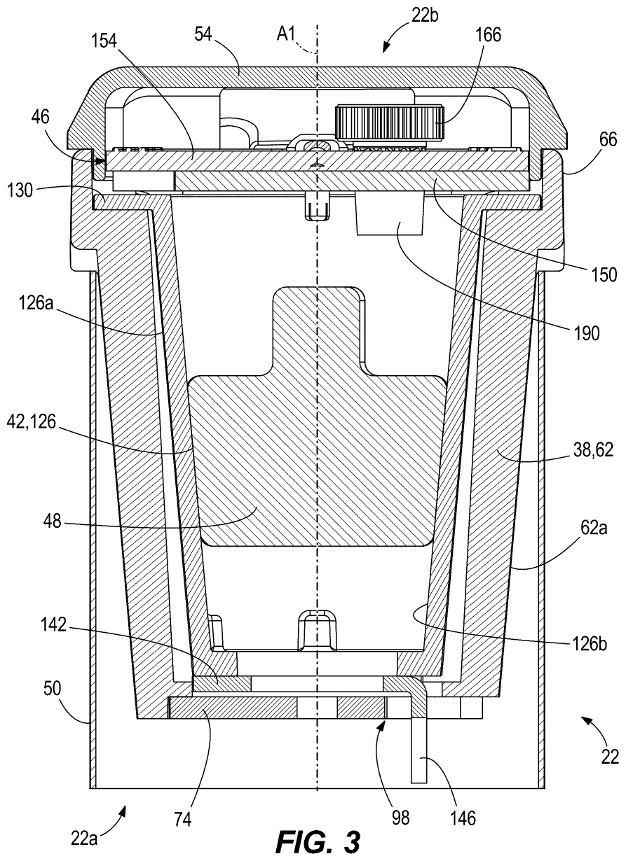

As illustrated in FIGS. 2 and 3, the handle 22 has a first end 22a and a second end 22b and defines an axis of rotation A1 that extends through the first end 22a and the second end 22b. The handle 22 is configured to be coupled to the valve member 18 at the first end 22a and is configured to be grasped by a user at the second end 22b for rotating the handle 22 about the axis of rotation A1. The handle 22 includes a body 38 that extends between the first end 22a and the second end 22b, a body insert 42 that is at least partially received in the body 38, an adjustable stop assembly 46 mounted to the body 38, a first insulator 48, a second insulator 50, and a cover 54 that is removably coupled to the body 38 at the second end 22b of the handle 22. A lock 58 may be selectively engaged with the handle 22 to secure, or lock, the valve assembly 10 in the closed state (FIG. 1A) and the open state (FIG. 1B).

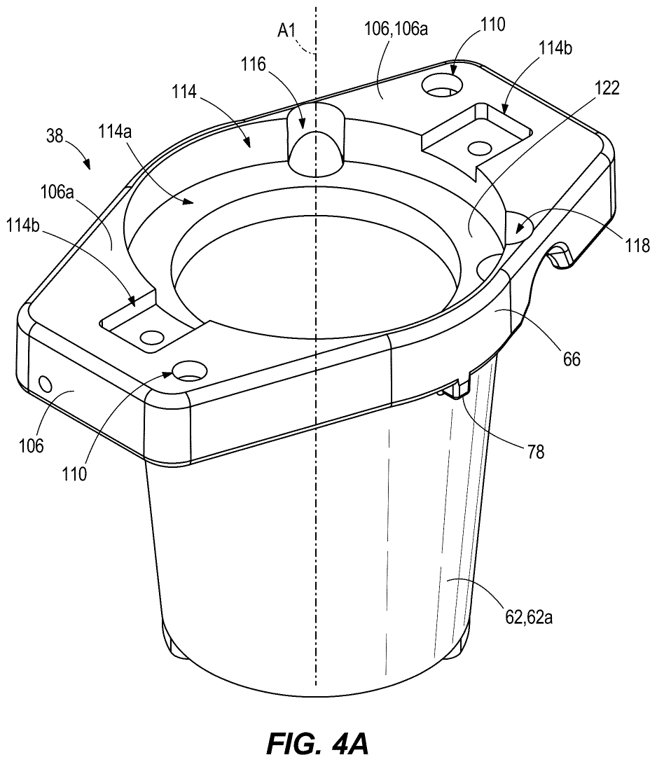

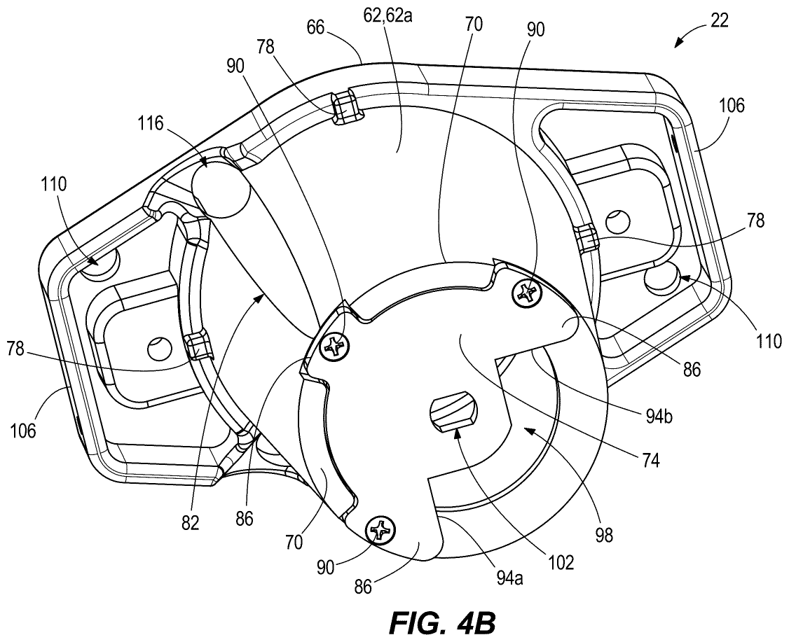

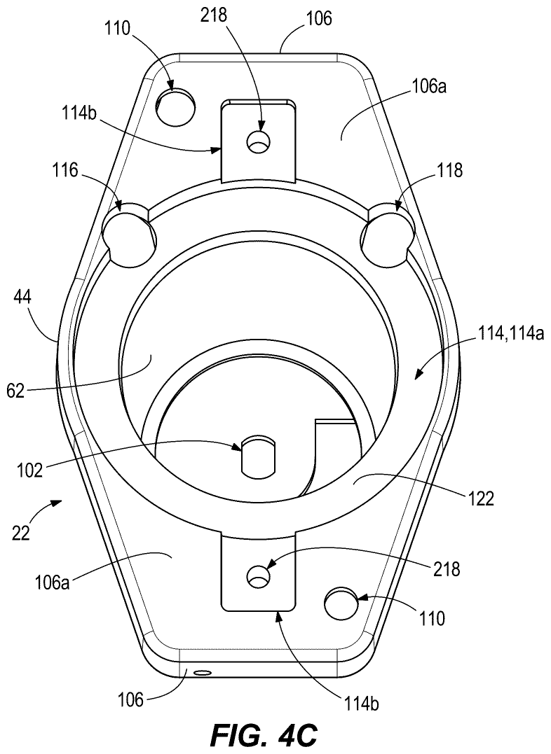

As illustrated in FIGS. 3-4C, the body 38 includes a sleeve 62 and a head 66. The sleeve 62 extends from the first end 22a of the handle 22 to the head 66 of the body 38. As such, the sleeve 62 may define the first end 22a of the handle 22. The head 66 is integrally formed with the sleeve 62 at the second end 22b of the handle 22. As such, the head 66 may define the second end 22b of the handle 22. In the illustrated embodiment, the sleeve 62 is substantially frustoconical and increases in diameter as the sleeve 62 extends along the axis of rotation A1 from the first end 22a of the handle 22 to the head 66. A plurality of first protrusions 70 and a plurality of fastener receptacles are formed by the sleeve 62 at the first end 22a of the handle 22. In the illustrated embodiment, the sleeve 62 includes two first protrusions 70 and three fastener receptacles. The plurality of first protrusions 70 and the plurality of fastener receptacles facilitate coupling of a first end plate 74 to the body 38, as will be described in more detail. A plurality of second protrusions 78 and locking grooves 82 are formed on or in the sleeve 62 adjacent to the head 66. The second protrusions 78 protrude from an outer surface 62a of the sleeve 62 and are uniformly spaced from one another at a location where the sleeve 62 meets the head 66. The locking grooves 82 are formed in the outer surface 62a of the sleeve 62 (e.g., as a recess in the outer surface 62a) and extend from the head 66 to the first end 22a of the handle 22 (FIG. 1A). The locking grooves 82 may be configured to at least partially receive the lock 58 when the lock 58 is engaged with the handle 22, as will be described in more detail.

With reference to FIGS. 3 and 4B, the first end plate 74 is coupled to the sleeve 62 at the first end 22a of the handle 22. The first end plate 74 includes a plurality of coupling tabs 86, and each of the coupling tabs 86 is configured to receive a fastener 90 that extends into a corresponding one of the plurality of fastener receptacles to couple the first end plate 74 to the sleeve 62. In the illustrated embodiment, the first end plate 74 includes three coupling tabs 86 corresponding to and overlapping three fastener receptacles formed in the body 38 at the first end 22a of the handle 22. Each of the coupling tabs 86 is positioned adjacent to at least one of the first protrusions 70. Specifically, one of the coupling tabs 86 is positioned between the two first protrusions 70, and each of the other two coupling tabs 86 is positioned at an opposite end of a corresponding first protrusion 70 from the one coupling tab 86. The first end plate 74 additionally includes a first shoulder 94a defined by one of the coupling tabs 86, a second shoulder 94b defined by another of the coupling tabs 86, and a first memory slot 98 defined between the first shoulder 94a and the second shoulder 94b. The first end plate 74 defines a stem aperture 102 that is configured to receive the stem 34 from the valve member 18 to place the handle 22 in engagement with the with the ball 30 of the valve member 18. In the illustrated embodiment, the stem aperture 102 is oblong-shaped to facilitate rotational coupling with the stem 34 of the valve member 18 (FIG. 1A). In other words, the oblong shape of the stem aperture 102 may inhibit relative rotation between the stem 34 (FIG. 1A) and the handle 22 when the stem 34 is inserted through the stem aperture 102.

The head 66 is graspable to facilitate rotation of the handle 22 for opening and closing the valve member 18. The head 66 is formed in the shape of an elongated hexagon and incudes head flanges 106 that protrude away from the outer surface 62a of the sleeve 62. In the illustrated embodiment, the head 66 includes two head flanges 106. In other embodiments, the head 66 may have other shapes. The head 66 defines cover receptacles 110 in the head flanges 106, a stop assembly receptacle 114 between the two head flanges 106, a first lock aperture 116, and a second lock aperture 118. In the illustrated embodiment, the head 66 defines two cover receptacles 110. The cover receptacles 110 are configured to receive coupling features from the cover 54, as will be described in more detail. The stop assembly receptacle 114 includes a circular portion 114a and two rectangular portions 114b. The circular portion 114a is positioned between the two head flanges 106 and includes a bottom surface 122 that is configured to support the body insert 42 and the adjustable stop assembly 46. Each of the two rectangular portions 114b extends from the circular portion 114a into a corresponding one of the head flanges 106 and may include an aperture, or receptacle, for receiving a fastener. The circular portion 114a has a greater depth than the rectangular portions 114b. Each of the lock apertures 116, 118 is partially defined by the bottom surface 122 of the circular portion 114a and the top surface 106a of one of the head flanges 106. That is, both of the lock apertures 116, 118 are partially defined by the top surface 106a of the same head flange 106. In the illustrated embodiment, roughly half of each of the lock apertures 116, 118 (e.g., a first semi-circle) is defined by the bottom surface 122 of the stop assembly receptacle 114 and the other half of each of the lock apertures 116, 118 (e.g., a second semi-circle) is defined by the top surface 106a of the one of the head flanges 106. The first lock aperture 116 is configured to receive the lock 58 to place the lock 58 in engagement with the handle 22 for locking the valve assembly 10 in the closed state, and the second lock aperture 118 is configured to receive the lock 58 to place the lock 58 in engagement with the handle 22 for locking the valve assembly 10 in the open state, as will be described in more detail.

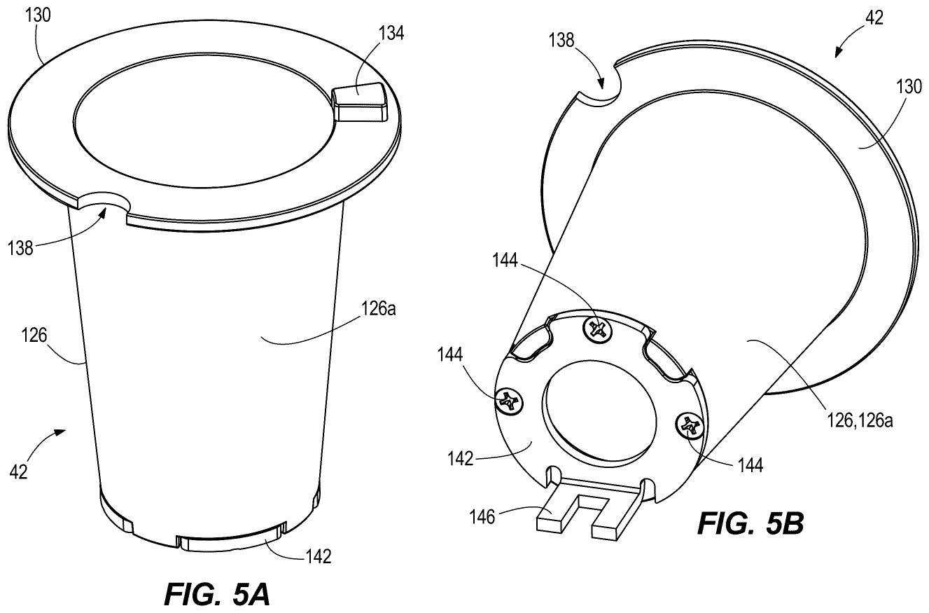

With reference to FIG. 3, the body insert 42 is configured to be received in the body 38. As illustrated in FIGS. 3, 5A, and 5B, the body insert 42 includes an insert sleeve 126 that extends into the body 38 and an insert flange 130 that rests on the bottom surface 122 of the circular portion 114a of the stop assembly receptacle 114 (FIG. 4A). The insert sleeve 126 extends along the axis of rotation A1 from a location adjacent the first end 22a of the handle 22 to the insert flange 130. The insert sleeve 126 may have a shape and a length (i.e., measured along the axis of rotation A1) that is substantially similar to the shape and length of the sleeve 62 of the body 38. As such, the insert sleeve 126 may increase in diameter as the insert sleeve 126 extends from the location adjacent to the first end 22a of the handle 22 to the insert flange 130. The insert flange 130 is integrally formed with the insert sleeve 126 and extends outwardly from an outer surface 126a of the insert sleeve 126 around the circumference of the insert sleeve 126. The insert flange 130 includes an insert protrusion 134 and defines an insert recess 138. The insert protrusion 134 extends from the insert flange 130 in a direction extending away from the insert sleeve 126. The insert recess 138 is defined in the insert flange 130 at an outer perimeter of the insert flange 130. In the illustrated embodiment, the insert recess 138 is semi-circular. In other embodiments, the insert recess 138 may have other shapes.

With reference to FIGS. 3 and 5B, a second end plate 142 is coupled to the body insert 42 adjacent to the first end 22a of the handle 22 and may rest on top of the first end plate 74. The second end plate 142 is coupled to the body insert 42 with fasteners 144 in a substantially similar fashion as the coupling between the first end plate 74 and the body 38. The second end plate 142 includes a tab 146 that protrudes from the second end plate 142 in a direction extending away from the insert sleeve 126. The tab 146 protrudes from the second end plate 142 and into the first memory slot 98. The location of the tab 146 within the first memory slot 98 may be adjusted between the first shoulder 94a and the second shoulder 94b of the first end plate 74 (FIG. 4B) based on the state of the valve assembly 10, as will be described in more detail.

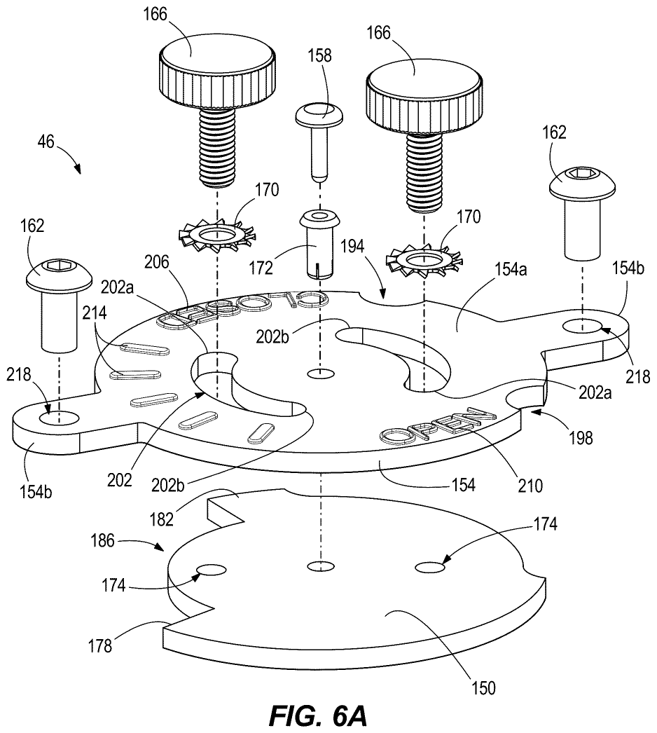

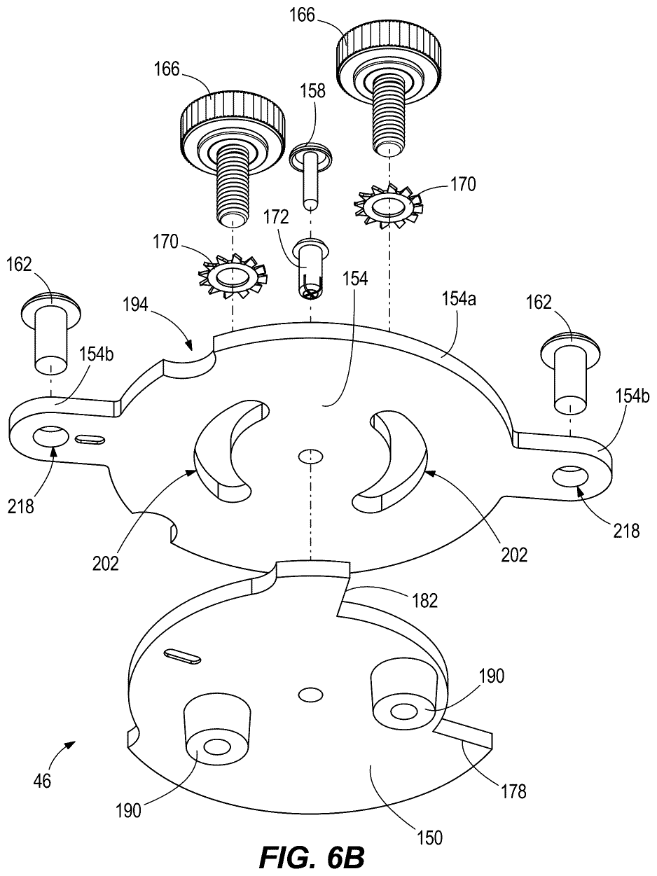

With reference to FIGS. 3, 6A, and 6B, the adjustable stop assembly 46 includes a first adjustment plate 150, a second adjustment plate 154 positioned on top of the first adjustment plate 150, a first fastener 158, a plurality of second fasteners 162, a plurality of third fasteners 166, and a plurality of washers 170. The adjustable stop assembly 46 is provided within the handle 22 as a means for, among other things, adjusting the valve assembly 10 to the memory-stop state.

The first adjustment plate 150 may also be referred to as a memory stop plate. The first adjustment plate 150 is received in the circular portion 114a of the stop assembly receptacle 114 and is supported on top of the insert flange 130 of the body insert 42. The first adjustment plate 150 includes a first fastener receptacle 172, a plurality of third fastener receptacles 174, first shoulder 178, a second shoulder 182, and a second memory slot 186 defined between the first shoulder 178 and the second shoulder 182. The first fastener receptacle 172 is provided at a center of the first adjustment plate 150 and at a center of the second adjustment plate 154 and is configured to receive the first fastener 158 for rotatably coupling the second adjustment plate 154 to the first adjustment plate 150. The third fastener receptacles 174 are provided radially outward of the first fastener receptacle 172 and are configured to receive the plurality of third fasteners 166. Each of the third fastener receptacles 174 include a bore 190 that extends from a bottom of the first adjustment plate 150. That is, the bore 190 of each of the third fastener receptacles 174 extends in a direction away from the second adjustment plate 154. In the illustrated embodiment, the first adjustment plate 150 includes two third fastener receptacles 174. The first shoulder 178 defines a first end of the second memory slot 186, and the second shoulder 182 defines a second end of the second memory slot 186. The second memory slot 186 is configured to receive the insert protrusion 134 of the body insert 42, and the location of the insert protrusion 134 within the second memory slot 186 is configured to be adjusted between the first end of the second memory slot 186 (i.e., the first shoulder 178) and the second end of the second memory slot 186 (i.e., the second shoulder 182). For example, in the closed state, the insert protrusion 134 may be positioned adjacent to the first shoulder 178, and in the open state, the insert protrusion 134 may be positioned adjacent to the second shoulder 182.

With reference to FIGS. 3, 4A, and 6A, the second adjustment plate 154 may also be referred to as a top plate. The second adjustment plate 154 includes a circular plate portion 154a and two plate flange portions 154b. In the illustrated embodiment, the second adjustment plate 154 may have a substantially similar shape as the stop assembly receptacle 114 formed in the head 66. The circular plate portion 154a corresponds to and is received in the circular portion 114a of the stop assembly receptacle 114. The circular plate portion 154a defines a first recess 194, a second recess 198, and a plurality of adjustment slots 202. Each of the first recess 194 and the second recess 198 is defined in the circular plate portion 154a of the second adjustment plate 154 at an outer perimeter of the circular plate portion 154a. In the illustrated embodiment, the recesses 194, 198 are semi-circular. In other embodiments, the recesses 194, 198 may have other shapes. The first recess 194 is configured to at least partially receive the lock 58 to lock the valve assembly 10 in the closed state, and the second recess 198 is configured to at least partially receive the lock 58 to lock the valve assembly 10 in the open state. The circular plate portion 154a includes first indicia 206 positioned adjacent to the first recess 194, second indicia 210 positioned adjacent to the second recess 198, and third indicia 214 positioned adjacent to at least one of the plurality of adjustment slots 202. In the illustrated embodiment, the first indicia 206 form the word, ‘CLOSED’, to indicate that the first recess 194 corresponds to the closed state, and the second indicia 210 form the word, ‘OPEN’, to indicate that the second recess 198 corresponds to the open state. In other embodiments, the first indicia 206 and the second indicia 210 may have other forms that indicate the valve assembly 10 is in the closed state and the open state, respectively. The third indicia 214 in the illustrated embodiment is a plurality of hash marks. Each of the hash marks may indicate a different memory-stop state position along the at least one of the plurality of adjustment slots 202. In the illustrated embodiment, the plurality of adjustment slots 202 includes two adjustment slots 202 and the third indicia 214 are provided along just one of the adjustment slots 202. In some embodiments, the plurality of adjustment slots 202 includes more than two slots 202. In other embodiments, the third indicia 214 may be provided along each of the adjustment slots 202.

Each of the two plate flange portions 154b corresponds to and is received in one of the rectangular portions 114b of the stop assembly receptacle 114. Each of the two plate flange portions 154b define a second fastener receptacle 218 that is configured to receive a corresponding one of the second fasteners 162. In the illustrated embodiment, the adjustable stop assembly 46 includes two second fasteners 162. Each of the second fasteners 162 extends through the second fastener receptacle 218 in one of the plate flange portions 154b and into a corresponding one of the rectangular portions 114b of the stop assembly receptacle 114 to fasten, or couple, the second adjustment plate 154 to the head 66 of the body 38. As such, the second fasteners 162 inhibit relative movement of the second adjustment plate 154 and the body 38. That is, the second fasteners 162 constrain the second adjustment plate 154 and the body 38 for co-rotation together.

In the illustrated embodiment, with reference to FIGS. 3, 6A, and 6B, the adjustable stop assembly 46 includes two third fasteners 166. Each of the third fasteners 166 is received in and is slidable, or movable, along one of the adjustment slots 202. Specifically, the third fasteners 166 extend through one of the adjustment slots 202 and into one of the third fastener receptacles 174, and more specifically, into the bore 190 of the third fastener receptacles 174 in the first adjustment plate 150. In the illustrated embodiment, the third fasteners 166 are thumb screws which may be loosened and tightened without the use of tools within the third fastener receptacles 174 to selectively allow the third fasteners 166 to slide along the adjustment slot 202 for adjusting the valve assembly 10 to the memory-stop state. With the third fasteners 166 loosened, the first adjustment plate 150 and the second adjustment plate 154 may rotate relative to one another. With the third fasteners 166 tightened, relative movement between the first adjustment plate 150 and the second adjustment plate 154 is inhibited. In the illustrated embodiment, the adjustable stop assembly 46 includes two washers 170. Each of the washers 170 is mounted to a corresponding one of the third fasteners 166 and is positioned between a screw head of the corresponding third fastener 166 and the second adjustment plate 154. The washers 170 increase the friction between the third fasteners 166 and the second adjustment plate 154 to increase the accuracy with which the valve assembly 10 is adjusted to a specific position in the memory-stop state.

With reference to FIGS. 3, 7, and 8A, the cover 54 is formed in a shape that is substantially similar in shape to the head 66 of the body 38. That is, the cover 54 is formed in the shape of an elongated hexagon. The cover 54 includes two cover protrusions 222 and defines a first cover aperture 226 and a second cover aperture 230. Each of the two cover protrusions 222 is configured to be received in a corresponding cover receptacle 110 in the head 66 of the body 38 to secure the cover 54 to the head 66 via a coupling force such as a friction-fit, a snap-fit, or another similar coupling force. Accordingly, the cover 54 may be removed from the head 66 through a user-force that overcomes the coupling force. The first cover aperture 226 is configured to receive the lock 58 to lock the valve assembly 10 in the closed state, and the second cover aperture 230 is configured to receive the lock 58 to lock the valve assembly 10 in the open state. With the cover 54 coupled to the head 66, the cover 54 inhibits engagement of the adjustable stop assembly 46, and more specifically, the third fasteners 166 by a user. Additionally, the cover 54 may be configured to block/inhibit environmental ingress from entering the handle 22, and more specifically, inhibit environmental ingress from reaching the adjustable stop assembly 46 while the cover 54 is attached to the body 38.

As illustrated in FIGS. 2 and 3, the first insulator 48 is a plug that is received and supported within the insert sleeve 126 of the body insert 42. The first insulator 48 may be formed of a compressible foam material. In the illustrated embodiment, the first insulator 48 may be compressed within the insert sleeve 126 to create a seal between the body insert 42 and the first insulator 48 that inhibits condensation forming on an exterior of the handle 22 due to temperature differentials between a top and a bottom of the handle 22. In other words, the first insulator 48 provides a thermal barrier between the top and the bottom of the handle 22. Specifically, the first insulator 48 provides a thermal barrier that inhibits heat from flowing across the first insulator, thereby inhibiting condensation from forming on the handle 22 (e.g., an exterior of the handle 22) due to temperature differentials.

With continued reference to FIGS. 2 and 3, the second insulator 50 is an insulation shield that surrounds the handle 22, and more specifically, surrounds the body 38. In the illustrated embodiment, the second insulator 50 is cylindrical and is hollow to allow the body 38 (and the body insert 42) to be inserted therethrough. The second insulator 50 may not be directly coupled to the body 38 such that the body 38 is configured to rotate relative to the second insulator 50. In other words, the second insulator 50 does not inhibit free use (i.e., rotation) of the handle 22. The second insulator 50 acts as a protective layer that surrounds the body 38 to protect against external fluid (e.g., liquid and gaseous fluids) and solid materials. For example, a user may spray an insulation foam or another similar insulation material around the shield (i.e., the second insulator 50) such that the shield inhibits the insulation foam from directly touching/engaging the handle 22, thereby allowing the handle 22 to rotate relative to the insulation foam.

As described above, the term, insulator, may be used to describe the plug and the shield. For the purposes of this disclosure, an insulator may be anything that inhibits thermal, fluid (e.g., liquid and/or gaseous fluids), and/or solid travel relative to at least a portion of the handle 22.

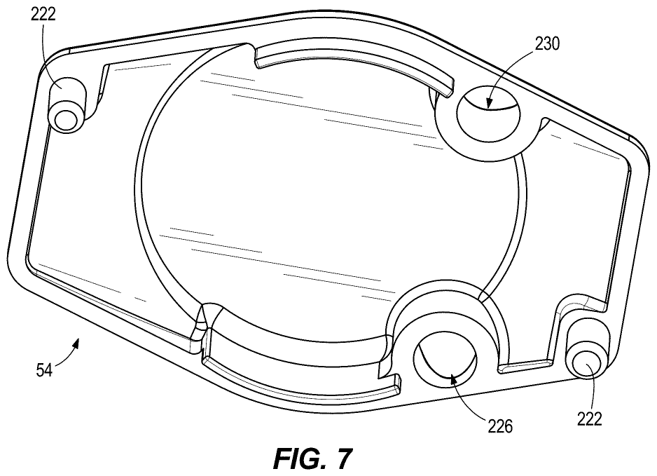

With reference to FIGS. 1A, 1B, and 3, in the illustrated embodiment, the lock 58 may be a padlock-type lock. In other embodiments, different types of locks may be considered. The lock 58 is configured to be engaged with the handle 22 to lock the valve assembly 10 in the closed state (FIG. 1A) and the open state (FIG. 1B). Specifically, when the valve assembly 10 is in the closed state, a shackle 58a of the lock 58 may be inserted through, in order of insertion, the first cover aperture 226 of the cover 54 (FIG. 7), the first lock aperture 116 at the top surface 106a of the head flange 106 (FIG. 4A), the first recess 194 of the second adjustment plate 154 (FIG. 6A), the insert recess 138 of the insert flange 130 of the body insert 42 (FIG. 5A), and the first lock aperture 116 at the bottom surface 122 of the stop assembly receptacle 114 (FIG. 4A). As such, the first cover aperture 226 (FIG. 7), the first lock aperture 116 (FIG. 4A), and the first recess 194 (FIG. 6A) may form a closed state lock receptacle. With the lock 58 inserted in the closed state lock receptacle, the lock 58 inhibits the valve assembly 10 from being adjusted to the open state and the memory-stop state. When the valve assembly 10 is in the open state, the shackle 58a of the lock 58 may be inserted through, in order of insertion, the second cover aperture 230 of the cover 54 (FIG. 7), the second lock aperture 118 at the top surface 106a of the head flange 106 (FIG. 4A), the second recess 198 of the second adjustment plate 154 (FIG. 6A), the insert recess 138 of the Insert flange 130 of the body insert 42 (FIG. 5A), and the second lock aperture 118 at the bottom surface 122 of the stop assembly receptacle 114 (FIG. 4A). As such, the second cover aperture 230 (FIG. 7), the second lock aperture 118 (FIG. 4A), and the second recess 198 (FIG. 6A) may form an open state lock receptacle. With the lock 58 inserted in the open state lock receptacle, the lock 58 inhibits the valve assembly 10 from being adjusted to the closed state and the memory-stop state. In the memory-stop state, both of the closed state lock receptacle and the open state lock receptacle are at least partially covered by the insert flange 130 of the body insert 42, as will be described in more detail, such that the valve assembly cannot be locked in the memory-stop state. In some embodiments, the handle 22 may include additional features to form a memory-stop state lock receptacle that enables the valve assembly 10 to be locked in the memory-stop state.

With reference to FIGS. 1A, in use of the valve assembly 10, the valve member 18 may be installed in the fluid flow system 14. The handle 22 may then be installed on the stem 34 of valve member 18 by inserting the stem 34 through the stem aperture 102 to rotationally engage the handle 22 with the ball 30. The handle 22 may be freely adjusted between the closed state (FIG. 1A) in which fluid is inhibited from flowing from the inlet end 26a to the outlet end 26b by the ball 30, the open state (FIG. 1B) in which a maximum amount of fluid is allowed to flow from the inlet end 26a of the pipe connector body 26 to the outlet end 26b of the pipe connector body 26 through the flow aperture 30a defined in the ball 30, and the memory-stop state in which a non-zero amount of fluid that is less than the maximum amount is allowed to flow from the inlet end 26a of the pipe connector body 26 to the outlet end 26b of the pipe connector body 26 through the ball 30.

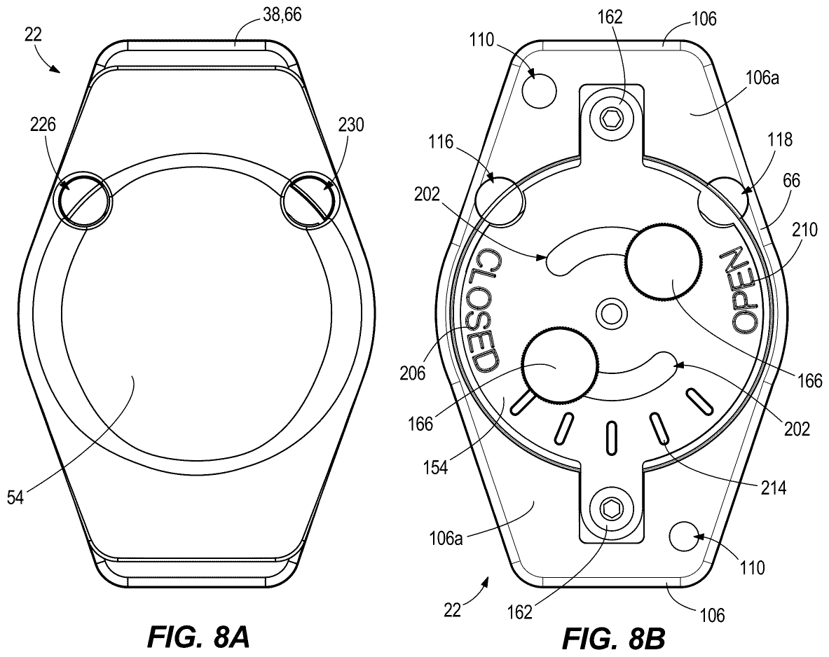

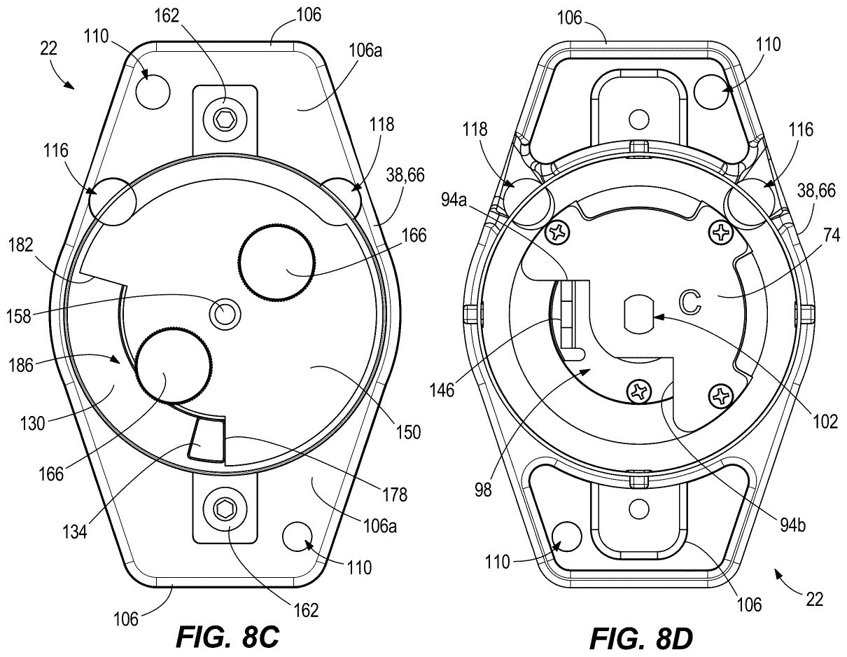

As illustrated in FIGS. 1A and 8A-8D, in the closed state, the insert protrusion 134 of the insert flange 130 is positioned at or adjacent to the first shoulder 178 of the first adjustment plate 150. Additionally, the tab 146 of the second end plate 142 is positioned at or adjacent to the first shoulder 94a of the first end plate 74. In the closed state, the insert flange 130 is aligned with the first cover aperture 226 of the cover 54 (FIG. 7), the first lock aperture 116 of the head flange 106 (FIG. 4A), and the first recess 194 of the second adjustment plate 154 (FIG. 6A) to form the closed state lock receptacle. If it is desired, a user may lock the valve assembly 10 in the closed state by inserting the shackle 58a into the closed state lock receptacle to inhibit the valve assembly 10 from being adjusted to the open state and/or the memory-stop state.

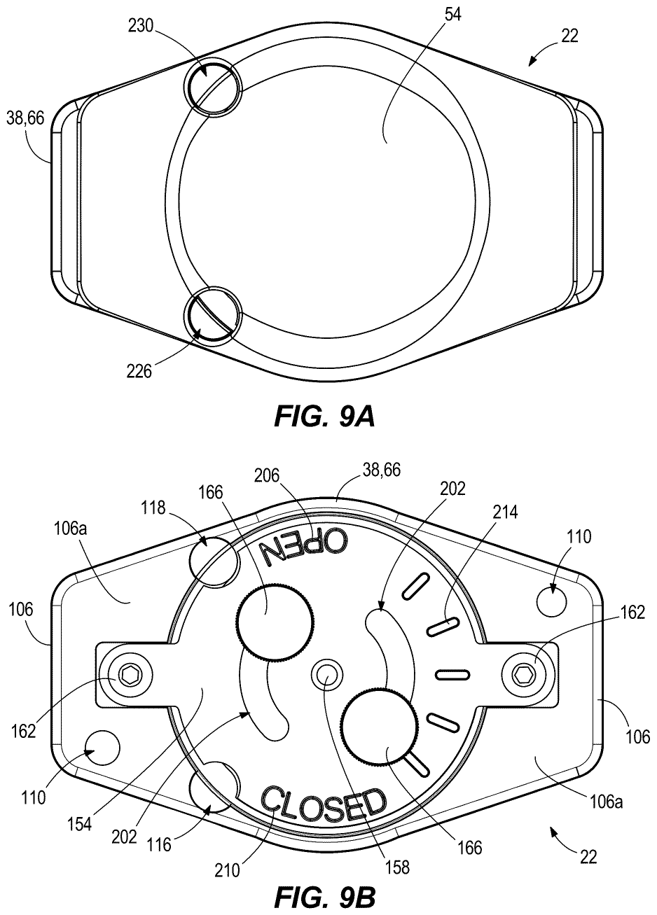

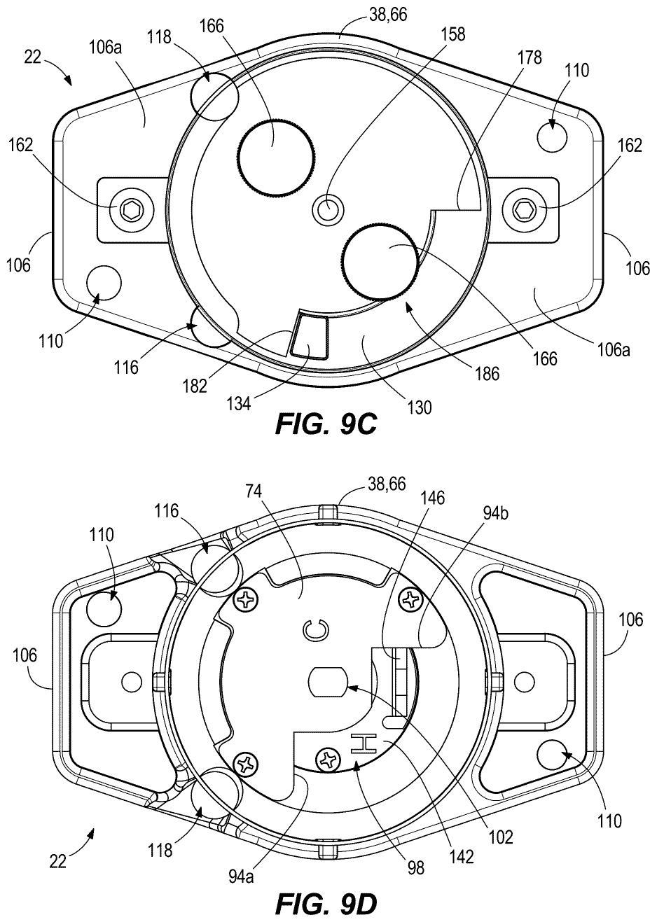

With reference to FIGS. 1A and 1B, to move the valve assembly 10 from the closed state (FIG. 1A) to the open state (FIG. 1B), a user may grasp the handle 22 (e.g., by the head 66) and rotate the handle roughly 90 degrees about the axis of rotation A1. In the illustrated embodiment, the handle 22 is rotated 90 degrees counterclockwise when viewing the assembly 10 from atop the handle 22. With reference to FIGS. 1B and 9A-9D, as the handle 22 is rotated, the body 38, the adjustable stop assembly 46, including the first adjustment plate 150 and the second adjustment plate 154, and the cover 54 are all constrained to rotate together relative to the body insert 42. As the body 38, the adjustable stop assembly 46, and the cover 54 are rotated the second cover aperture 230 of the cover 54 (FIG. 7), the second lock aperture 118 of the head flange 106 (FIG. 4A), and the second recess 198 of the second adjustment plate 154 (FIG. 6A) move into alignment with the flange recess 138 of the insert flange 130 to form the open state lock receptacle. Additionally, as the first adjustment plate 150 rotates, the location of the insert protrusion 134 of the insert flange 130 within the second memory slot 186 changes until the insert protrusion 134 is positioned at or adjacent to the second shoulder 182. It is understood that while the location of the insert protrusion 134 of the insert flange 130 within the second memory slot 186 changes from being adjacent to the first shoulder 178 in FIG. 8C to being adjacent to the second shoulder 182 in FIG. 9C, a user may stop rotation of the handle 22 at any position within the second memory slot 186 between the first shoulder 178 and the second shoulder 182. During rotation of the handle 22, the tab 146 of the second end plate 142 has a similar location change within the first memory slot 98 as the location change of the insert protrusion 134 within the second memory slot 186. That is, for example, the tab 146 may change locations from being at or adjacent to the first shoulder 94a of the first end plate 74 to being at or adjacent to the second shoulder 94b of the first end plate 74. If it is desired, a user may lock the valve assembly 10 in the open state by inserting the shackle 58a into the open state lock receptacle to inhibit the valve assembly 10 from being adjusted to the closed state and/or the memory-stop state.

The memory-stop state is defined as a state of the valve assembly 10 in which the adjustable stop assembly 46 is set to a position that allows a user to repeatably open the handle 22 by a set amount to throttle the valve member 18. During throttling of the valve member 18 while valve assembly 10 is in the memory-stop state, the flow aperture 30a of the ball 30 is only partially open. It is understood that the valve assembly 10 need not be placed in the memory-stop state in order to only partially open the flow aperture 30a of the ball 30. For example, a user may rotate the handle 22 by any desired amount to only partially open the flow aperture 30a of the ball 30 at any given time throughout the use of the valve assembly 10. However, placing the valve assembly 10 in the memory-stop state allows the user to repeatably open the flow aperture 30a of the ball 30 by the same partial amount, thereby increasing the ease of use of the valve assembly 10.

In the memory-stop state, the first adjustment plate 150 may be adjusted (e.g., rotated) relative to the body 38 and the second adjustment plate 154 such that the distance between the shoulders 178, 182 of the first adjustment plate 150 and the insert protrusion 134 changes. To adjust the valve assembly 10 to the memory-stop state, the valve assembly 10 is first placed in the closed state, a position between the closed state and the desired memory-stop state, or in the desired memory-stop state, and the cover 54 may be removed to provide a user with access to the adjustable stop assembly 46. A user may then loosen the third fasteners 166, thereby allowing the first adjustment plate 150 to rotate about the first fastener 158 relative to the second plate 154. With the third fasteners 166 loosened, a user may slide the third fasteners 166 along the adjustment slots 202. Due to the engagement between the third fasteners and the bores 190 (FIG. 6B) of the first adjustment plate 150, sliding the third fasteners 166 induces the first adjustment plate 150 to rotate about the first fastener 158 relative to the second adjustment plate 154, thereby moving the first shoulder 178 away from the insert protrusion 134. The third fasteners 166 may slide along the adjustment slots 202 between ends 202a, 202b of the adjustment slots 202, and the third fasteners 166 may be tightened to secure the third fasteners 166 at any point along the adjustment slots 202. The first adjustment plate 150 is configured to rotate infinitely along a distance that corresponds to the distance between ends 202a, 202b of the adjustment slot 202. As the first adjustment plate 150 is rotated relative to the body 38 and the second adjustment plate 154, the insert recess 138 remains aligned with the first cover aperture 226 of the cover 54 (FIG. 7), the first lock aperture 116 of the head flange 106 (FIG. 4A), and the first recess 194 of the second adjustment plate 154 (FIG. 6A) such that the valve assembly 10 may still be locked in the closed state by inserting the shackle 58a of the lock 58 in to the closed stated lock receptacle.

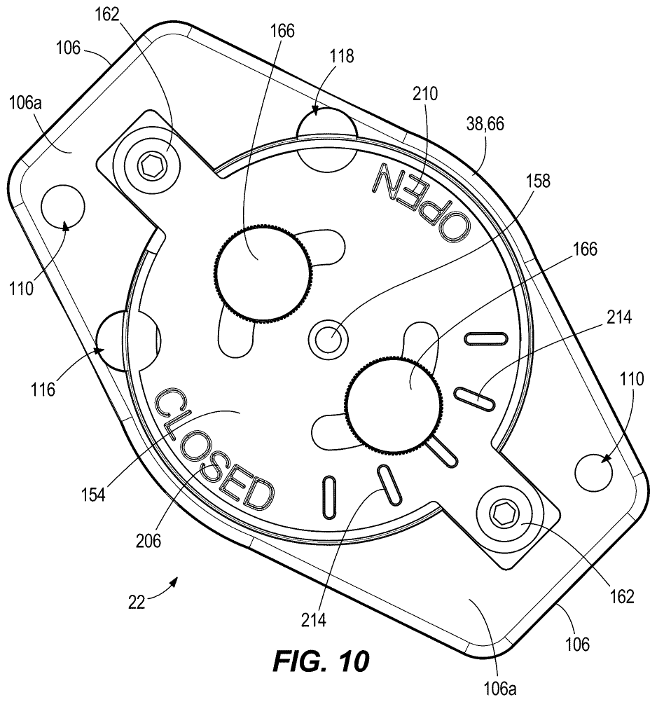

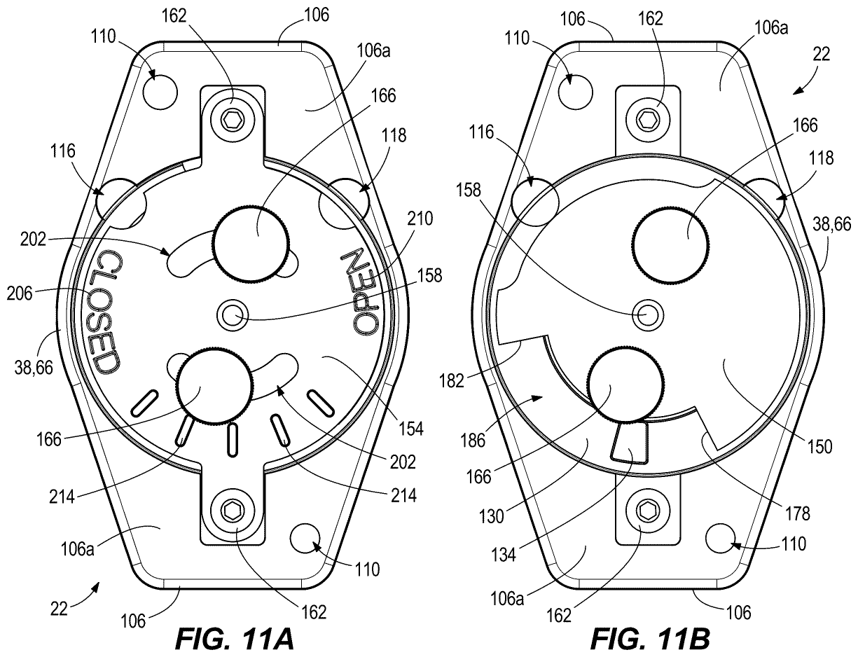

Once the first adjustment plate 150 has been rotated, with reference to FIGS. 10-11B, a user may grasp the head 66 to rotate the handle 22 by the remaining rotational distance between the insert protrusion 134 and the second shoulder 182. Due to the rotation of the first adjustment plate 150, the remaining rotational distance is less than the distance between the insert protrusion 134 and the second shoulder 182 when the valve assembly 10 is in the closed state. As a results, engagement between the insert protrusion 134 and the second shoulder 182 occurs prior to a full 90-degree rotation of the handle 22. Accordingly, with reference to FIG. 1C, rotating the handle 22 when the valve assembly 10 is in the memory-stop state only partially opens the valve member 18 (e.g., fluid may only enter through a portion of the flow aperture 30a) such that the valve member 18 permits an amount of fluid to flow from the inlet end 26a to the outlet end 26b that is less than a maximum amount of fluid allowed to flow from the inlet end 26a to the outlet end 26b when the valve assembly 10 is in the open state. Additionally, as the valve assembly 10 is opened in the memory-stop state, the body 38, the cover 54, and the second adjustment plate 154 rotate by an amount that places the insert recess 138 out of alignment with the closed state lock receptacle and the open state lock receptacle such that the valve assembly cannot be locked in the memory-stop state.

In the illustrated embodiment, the valve assembly 10 cannot be adjusted to the memory-stop state from the open state because the third fasteners 166 are constrained by the adjustment slots 202 from moving in the rotational direction required to change the distance between the inner protrusion 134 and the shoulders 178, 182 of the first adjustment plate 150. That is, for example with reference to FIG. 9C, the first adjustment plate 150 would need to rotate in a clockwise direction to change the distance between the insert protrusion 134 and the shoulders 178, 182. However, with reference to FIG. 9B, the third fasteners 166 are positioned at an end (e.g., a clockwise end) of the adjustment slots 202.

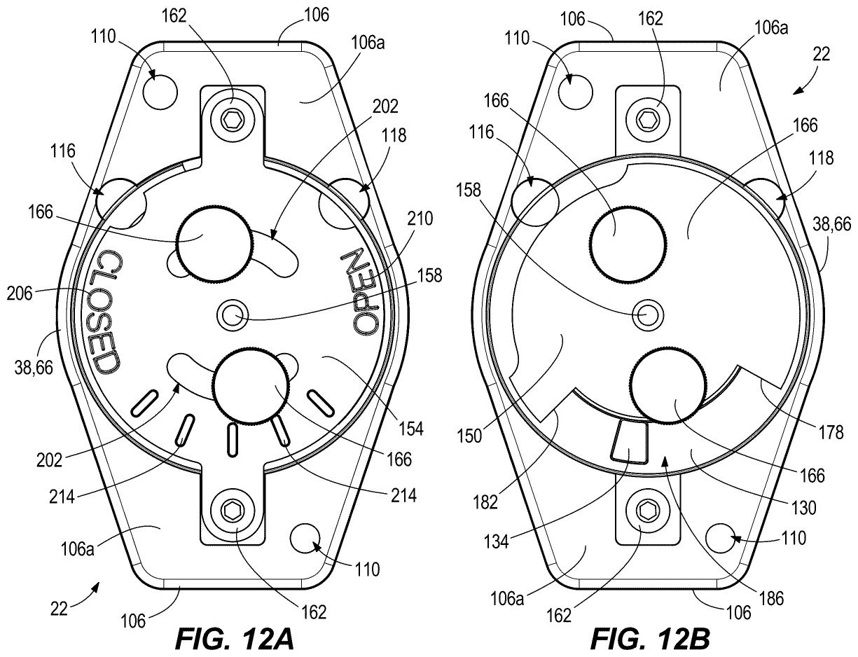

FIGS. 11A and 11B illustrate an exemplary first memory-stop state position, or orientation, and FIG. 12A and FIG. 12B illustrate an exemplary second memory-stop state position, or orientation. With reference to FIGS. 1C and 11A-12B, in the exemplary first memory-stop state position, the first adjustment plate 150 has been adjusted a relatively shorter rotational distance than the first adjustment plate 150 in the exemplary second memory-stop state position. As such, the valve assembly 10 may be opened by a greater amount (e.g., the ball 30 may be opened by a greater amount such that more of the flow aperture 30a is exposed) when the first adjustment plate 150 is in the first memory-stop state position than when the first adjustment plate 150 is in the second memory-stop state position. Accordingly, the less that the first adjustment plate 150 is rotated, the more fluid that is allowed to flow past the ball 30 of the valve member 18, and the more that the first adjustment plate 150 is rotated, the less fluid that is allowed to flow past the ball 30 of the valve member 18.

The adjustable stop assembly 46 advantageously allows a user to set a specific amount of flow that is permitted to flow between the inlet end 26a and the outlet end 26b of the pipe connector body 26. As described above, a user may rotate the handle 22 from the closed state to the open state or stop at any rotational distance prior to reaching open state. However, the adjustable stop assembly 46 provides a user with the means for setting a specific stopping point between the open state and the closed state. With the specific stopping point set, a user may more easily open and close the ball 30 to allow a desired amount of fluid flow through the pipe connector body 26 in a repeatable fashion.

Although the disclosure has been described in detail with reference to certain preferred implementations, variations and modifications exist within the scope and spirit of one or more independent aspects of the disclosure as described.

Various features and aspects of the present disclosure are set forth in the following claims.

What is claimed is:

1. A valve assembly comprising:
a valve member including
a pipe connector body configured to be installed in a fluid flow system,
a ball positioned within the pipe connector body and rotatable relative to the pipe connector body to selectively permit and inhibit fluid flow from the fluid flow system through the pipe connector body; and
a handle including
a body configured to be coupled to the valve member at an end of the body, the body including a head positioned opposite from the end of the body that is coupled to the valve member, the head graspable to open and close the valve member,
a body insert received in the body, the body insert including a flange and a tab that protrudes from the flange in a direction away from the end of the body that is coupled to the valve member, and
an adjustable stop assembly engaged with the body insert, the adjustable stop assembly including
a first plate positioned on the flange of the body insert, the first plate rotatable relative to the body insert between an open state, a closed state, and a memory-stop state, each of the open state, the closed state, and the memory-stop state corresponding to a different orientation of the valve member,
a second plate positioned on top of the first plate such that the first plate is positioned between the body insert and the second plate, and
a fastener that couples the first plate and the second plate together, the fastener engageable by a user to move the first plate to the memory-stop state,
wherein opening the handle while the first plate is in the memory-stop state is configured to at least partially open the valve member.

2. The valve assembly of claim 1, wherein the open state corresponds to an orientation of the valve member in which the ball permits a maximum amount of fluid flow through the pipe connector body, wherein the closed state corresponds to an orientation of the valve member in which the ball inhibits fluid flow through the pipe connector body, and wherein the memory-stop state corresponds to any orientation of the ball in which the ball permits a non-zero amount of fluid flow through the pipe connector body that is less than the maximum amount permitted in the open state.

3. The valve assembly of claim 1, wherein the first plate includes a first shoulder, a second shoulder, and a slot defined between the first shoulder and the second shoulder, wherein in the open state, the tab is positioned adjacent to the first shoulder, wherein in the closed state, the tab is positioned adjacent to the second shoulder, and wherein in the memory-stop state, the tab is positioned at any location along the slot between the first shoulder and the second shoulder.

4. The valve assembly of claim 1, wherein the fastener is selectively tightenable without using tools to couple the second plate to the first plate and inhibit movement of the first plate relative to the second plate, and wherein the fastener is selectively loosenable without using tools to permit movement of the first plate relative to the second plate.

5. The valve assembly of claim 4, wherein the second plate includes an adjustment slot and the fastener is inserted through the adjustment slot to couple the second plate to the first plate, and wherein with the fastener loosened, the fastener is movable along the adjustment slot to move the first plate to the memory-stop state.

6. The valve assembly of claim 5, wherein the adjustment slot includes a first end and a second end, wherein with the fastener positioned at one of the first end and the second end, the first plate is in the closed state.

7. The valve assembly of claim 5, wherein the fastener is a first fastener, the adjustable stop assembly further including a second fastener, wherein the adjustment slot is a first adjustment slot, the adjustable stop assembly further including a second adjustment slot and the second fastener is inserted through the second adjustment slot to couple the second plate to the first plate, and wherein with the second fastener loosened, the second fastener is movable along the second adjustment slot to move the first plate to the memory-stop state.

8. The valve assembly of claim 7, wherein with at least one of the first fastener and the second fastener tightened, the first plate is inhibited from being adjusted to the memory-stop state, and wherein with both of the first fastener and the second fastener loosened, the first plate is permitted to be adjusted to the memory-stop state.

9. The valve assembly of claim 5, wherein the fastener is a thumb screw.

10. The valve assembly of claim 1, wherein the handle further includes a removable cover that is selectively coupled to the body to surround the fastener such that the cover inhibits engagement of the fastener while the cover is coupled to the body.

11. The valve assembly of claim 1, wherein the handle further includes
an insulator that inhibits condensation forming on an exterior of the handle from temperature differentials, and
a lock engageable with the adjustable stop assembly to lock the first plate in either the open state or the closed state.

12. A valve assembly comprising:
a valve member including
a pipe connector body configured to be installed in a fluid flow system, and
a ball positioned within the pipe connector body and rotatable relative to the pipe connector body to selectively permit and inhibit fluid flow from the fluid flow system through the pipe connector body; and
a handle including
a body coupled to the valve member at an end of the body,
a body insert received in the body, the body insert including a flange and a tab that protrudes from the flange in a direction away from the end of the body that is coupled to the valve member,
an adjustable stop assembly engaged with the body insert, the adjustable stop assembly including a plate rotatable relative to the body insert between an open state, a closed state, and a memory-stop state, each of the open state, the closed state, and the memory-stop state corresponding to a different orientation of the valve member;
an insulator secured to one of the body and the body insert to inhibit condensation from forming on an exterior of the handle due to temperature differentials; and
a lock engageable with the adjustable stop assembly to lock the plate in either the open state or the closed state.

13. The valve assembly of claim 12, wherein the lock is selectively insertable into a lock receptacle to lock the plate in either the open state or the closed state, and wherein each of the body, the body insert, and the plate at least partially defines the lock receptacle.

14. The valve assembly of claim 13, wherein adjustment stop assembly includes a first plate and a second plate on top of the first plate, wherein a body insert recess is formed in the flange of the body insert, wherein a first recess and a second recess are formed in the second plate, wherein with the adjustment stop assembly in the closed state, the first recess is aligned with the body insert such that the body insert recess and the first recess are configured to receive the lock to inhibit the adjustment stop assembly from being adjusted from the open state, and wherein with the adjustment stop assembly in the open state, the second recess is aligned with the body insert such that the body insert recess and the second recess are configured to receive the lock to inhibit the adjustment stop assembly from being adjusted from the closed state.

15. The valve assembly of claim 12, wherein the insulator is a plug that is supported within the body insert and creates a seal between the end of the body that is coupled to the valve member and the adjustable stop assembly.

16. The valve assembly of claim 12, wherein the insulator is a shield that surrounds the body to inhibit environmental ingress from entering handle.

17. The valve assembly of claim 12, wherein the insulator is a first insulator that is positioned within the body insert, the handle further including a second insulator that surrounds the body of the handle.

18. A handle for a valve assembly having a valve member, the handle comprising:
a body configured to be coupled to the valve member at an end of the body, the body including a head positioned opposite from the end of the body that is coupled to the valve member, the head graspable to open and close the valve member;
a body insert received in the body, the body insert including a flange and a tab that protrudes from the flange in a direction away from the end of the body that is coupled to the valve member; and
an adjustable stop assembly engaged with the body insert, the adjustable stop assembly including
a first plate positioned on the flange of the body insert, the first plate rotatable relative to the body insert between an open state, a closed state, and a memory-stop state, each of the open state, the closed state, and the memory-stop state corresponding to a different orientation of the valve member,
a second plate positioned on top of the first plate such that the first plate is positioned between the body insert and the second plate, and
a fastener that couples the first plate and the second plate together, the fastener engageable by a user to move the first plate to the memory-stop state,
wherein the valve member is at least partially open when the first plate is in the memory-stop state.

19. The handle of claim 18, wherein the first plate includes a first shoulder, a second shoulder, and a slot defined between the first shoulder and the second shoulder, wherein in the open state, the tab is positioned adjacent to the first shoulder, wherein in the closed state, the tab is positioned adjacent to the second shoulder, and wherein in the memory-stop state, the tab is positioned at any location along the slot between the first shoulder and the second shoulder.

20. The handle of claim 18, wherein the handle further includes
an insulator secured to the body to inhibit condensation forming on an exterior of the handle from temperature differentials, and
a lock engageable with the adjustable stop assembly to lock the first plate in either the open state or the closed state.
